(19) United States
(12) Patent Application Publication
(10) Pub. No.: US 2007/0266251 A1
(43) Pub. Date: Nov. 15, 2007

(54) Circuit Arrangement And Method For Securing Communication Within Communication Networks

(76) Inventors: Jens-Uwe Busser, Munchen (DE); Gerald Volkmann, Strausberg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/587,273

(22) PCT Filed: Jan. 28, 2005
(86) PCT No.: PCT/EP05/50360

§ 371 Date: May 24, 2007

(30) Foreign Application Priority Data
Jan. 29, 2004 (DE) 10 2004 004 606.9

(51) Int. Cl. H04L 9/00

(52) U.S. Cl. 713/176

(57) ABSTRACT

In one aspect, a circuit arrangement and associated method for the authentication of a network subscriber is provided. A digital certificate is stored as a resource in the P2P network. The data can then be provided for the other network subscriber, when the network subscriber(s) are offline or can not be reached for other reasons. It is also possible to encode data which is specific for other network units and file said data in a protective manner for the P2P network.

Securing communication is becoming ever more important in modern communication networks. Important aspects of securing communication are the authenticity of the subscribers and the confidentiality of the messages. Authorization may also be required to participate in a communication within networks. This securing of communication is usually implemented using pre-administrated common secrets, such as shared secrets. Securing of communication may also be ensured using digital signatures/certificates. In this case each network subscriber authorized for secure communication receives a separate digital certificate from a trustworthy central entity. These certificates link a public key to the identity of its owner. These certificates may be checked with the public key of the central entity, said key being contained in what is known as the root certificate of the central entity, which has to be distributed to all network subscribers in an uncorrupted manner. Using its secret, private key a network subscriber can accordingly generate a signed message, the authenticity of which can be checked by any receiver by means of the public key from the network subscriber's certificate. The receiver receives the network subscriber's certificate either from the network subscriber itself or from a central server. For confidential transmission of messages, said messages are encrypted using the public key from the receiver's certificate, so only the receiver can decrypt the message again.

Security functions, such as authentication, authorization and encryption/decryption are also used in a peer-to-peer network, hereinafter abbreviated to P2P network. If information is accordingly required from a network subscriber's certificate, the certificate can be requested from this network unit itself, or, if available, from an external memory unit.

However, the previously described authentication of data or messages of a network unit in a P2P network bring with it the disadvantage that a certificate server must always be available to the subscriber of the P2P network and/or the network subscribers must always be in online mode. Furthermore, in general, confidential messages for network subscribers may no longer be stored for specific network subscribers if the above-mentioned network conditions and network subscriber conditions exist.

The object of the invention is to disclose a circuit arrangement and an associated method for securing network subscriber communication.

The object is achieved by the features of claims 1 and 4.

The invention brings with it the advantage that an authentication check may be carried out even if the network subscriber is in offline mode.

The invention brings with it the advantage that an authentication check can be carried out via the network subscriber's certificate even if the network subscriber is in offline mode.

The invention brings with it the advantage that storing of confidential information can be carried out in the P2P network even if the network subscriber is in offline mode.

The invention brings with it the advantage that servers are not required to provide created and stored certificates in day-to-day operation.

Further particular features of the invention can be found in the following, more detailed descriptions of the figures of an embodiment, in which:

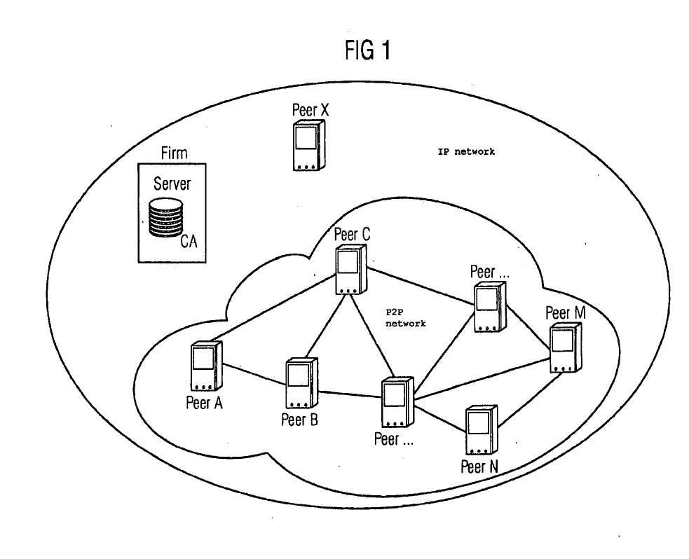

FIG. 1 shows a P2P network within an IP network,

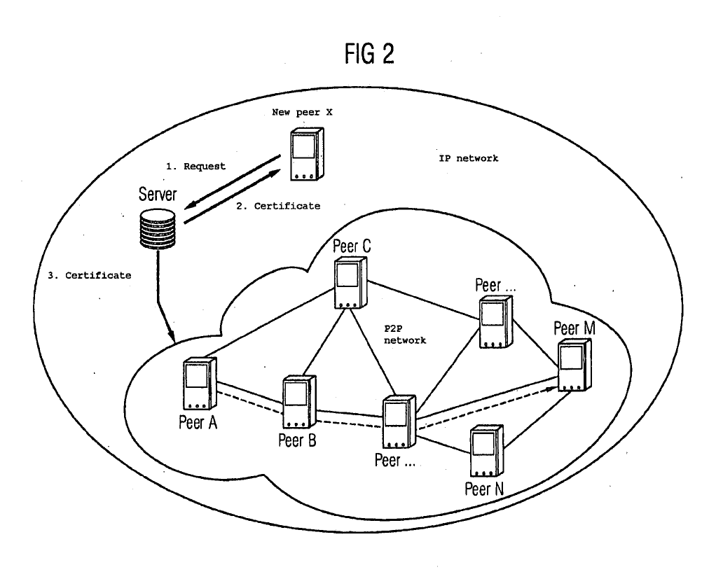

FIG. 2 shows an allocation of a certificate for a new network subscriber and the distribution thereof in the P2P network,

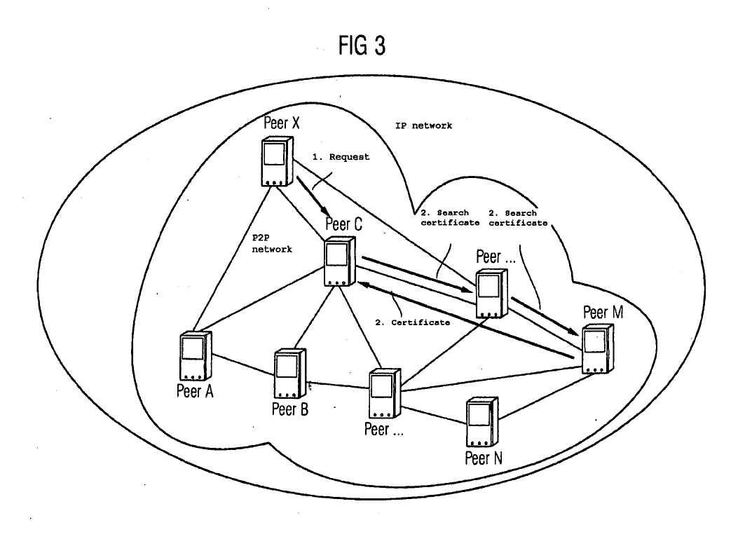

FIG. 3 shows a schematic illustration of the authentication of the message of a network subscriber,

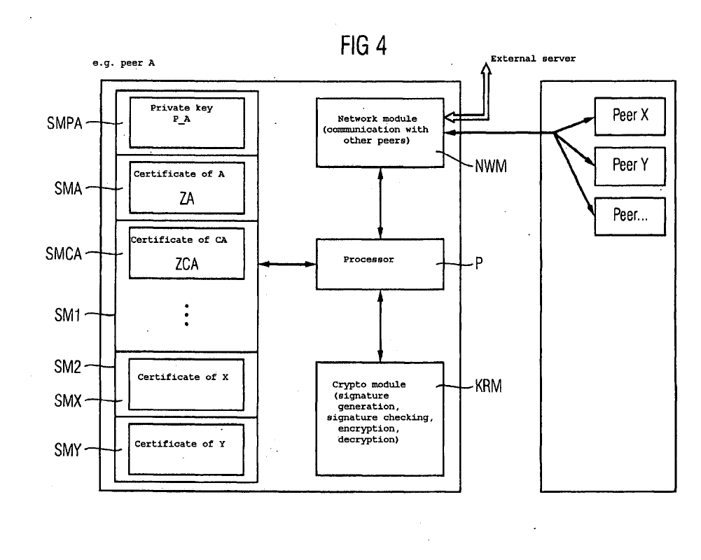

FIG. 4 shows a construction of circuit modules within a peer,

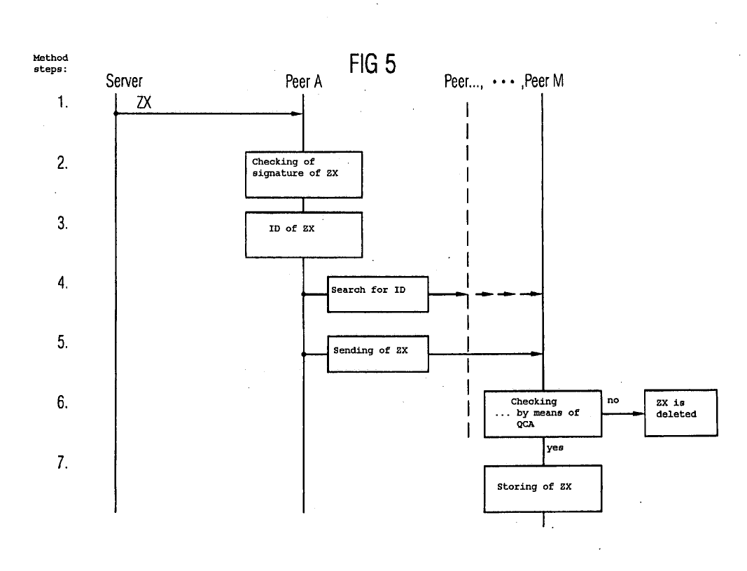

FIG. 5 shows a flow diagram of a certificate distribution,

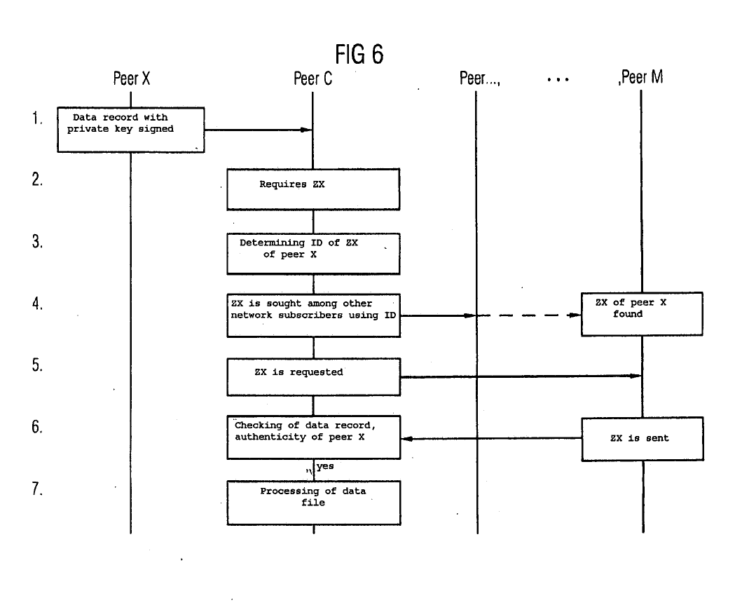

FIG. 6 shows a flow diagram of an authentication check, and

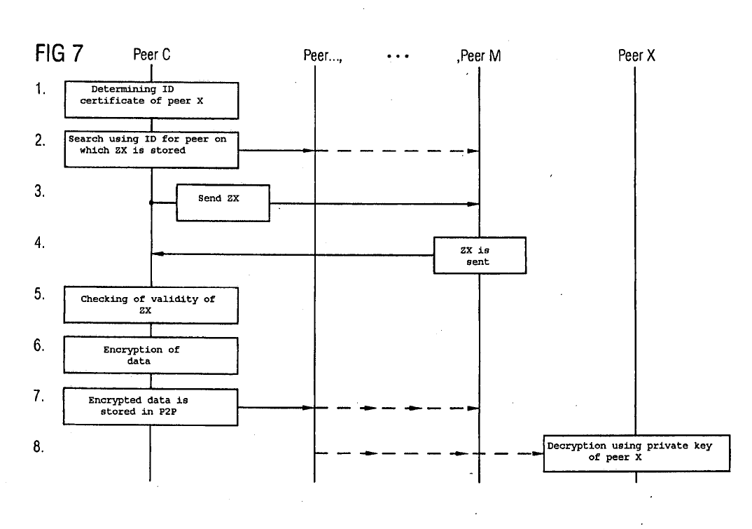

FIG. 7 shows a flow diagram of an encrypted storing procedure.

A digital certificate is stored as a resource in the P2P network using a circuit arrangement and the associated method for authenticating a network subscriber. This brings with it the advantage that data can be made available to further network subscribers even if the network subscriber(s) is/are in the offline operating mode or is/are not available for other reasons. It is also possible, moreover, for network units to encrypt specific data and to thus store it in the P2P network in a protected manner.

FIG. 1 shows a P2P network within a network designated IP.

The data transfer through to the transport layer takes place via conventional protocols, for example the internet protocol. The layer of the P2P protocol, which undertakes the allocation of identification ID to other subscribers and data records, regulates the saving, extracting and replication of data records, etc., is located as an additional layer between the transport layer and the application layer.

The elements designated “peer”: peer A, peer B, . . . peer N, of the P2P network are, for example, independent computers which are connected among themselves and to each other for example via both IP protocol and P2P protocol. The technology of a P2P network assumed here is known, for example, from a thesis by Thomas Friese at Philipps University, Marburg entitled “Selbstorganisierende Peer-to-Peer Netzwerke” (Self-organizing Peer-to-Peer Networks) and dated March 2002. A server or certificate server of a service provider for example may likewise be disposed within the IP network.

The subject-matter of the invention will be explained with reference to the description of the figures below. It is intended in this case that a network element designated peer X will receive access for example to network subscribers of a network designated P2P.

FIG. 2 schematically describes access of the network subscriber peer X to the P2P network. In a first method step a certificate ZX is requested by network subscriber peer X, which may, for example, be a computer, from a provider FIRM. The provider FIRM sends the applicant peer X the allocated certificate likewise stored in the certificate server CA. This certificate ZX established by the certificate server for the network subscriber peer X consists for example of various rubrics, such as name of the provider, the company or the trust center issuing the certificate, a serial number of the certificate, a public key of peer X, a validity period, a name of who the key belongs to (peer X) and a signature which is generated by the provider or trust center. The signature ensures that the data stored in the certificate has only been issued by the trust center or the company or the provider. In a second step this certificate ZX is sent to the new network subscriber peer X of the P2P network. The certificate ZX is also sent to the P2P network by the certificate server CA which views the P2P network as a whole. The certificate server CA for example sends the certificate ZX for this purpose to peer A. Peer A can hereby assume a gateway function. The certificate ZX is then stored within the P2P network as a resource, for example in peer M.

With the storing of the digital certificate as a resource in the P2P network the information of the digital certificate is available to the network subscribers of the P2P network even if the network unit peer X is in the offline operating mode or unavailable for other reasons. The validity period of this resource corresponds in this case to the validity period of the certificate. It is thus possible to access a public key, which is stored in the certificate, in order to check the authenticity of the information stored and signed in a network unit in the P2P network. Authorization of the certificate user results from the possession of a valid certificate issued by the provider FIRM. It is also possible for a network subscriber to encrypt specific information and thus store it in the P2P network in a protected manner. A confidential caller response function by way of example could thus be achieved.

FIG. 3 schematically reproduces how the network subscriber peer C receives a message from network subscriber peer X, the authenticity of which is to be checked by peer C. For this purpose peer C requires the certificate ZX from peer X. This certificate ZX extracts peer C from the P2P network and loads it into its memory. For this purpose peer C determines the identification ID of the certificate ZX according to the method set down in the P2P algorithm used and using the method set down in the P2P algorithm used then searches for a peer of which the identification optimally matches the ID of the certificate, and in the memory of which the certificate ZX has therefore been stored.

After the certificate ZX has been found in the resource of the network subscriber peer M, the certificate ZX is sent to the searching network subscriber peer C. Peer C accordingly first checks the validity of the certificate ZX by means of the public key QCA from the root certificate ZCA. It then checks the authenticity of the message by means of the public key QX which is contained in certificate ZX. If the authenticity is confirmed, the message is processed; otherwise it is ignored.

FIG. 4 schematically describes the construction of a network subscriber peer A. For the purpose of understanding the invention a network module NWM, a first memory module SMPA, SMCA, SMA, . . . and a second memory module SMX, SMY, . . . a crypto module KRM and a processor P connected to these modules are incorporated in the illustration. The network module NWM with network card and associated software, etc. regulates communication with all external devices, for example between peers in the P2P network and at the internet protocol-based IP level. A private key PA of peer A is stored in memory module SMPA. This key must be kept secret by peer A. The certificate of peer A with public key QA is in memory module SMA and a certificate of server CA with public key QCA is in memory module SMCA. These first three data records are always present in any peer. Certificates of other peers X, Y, . . . are stored in a second memory module and are retrieved from the P2P network if required. The crypto module KRW, which is constructed in terms of software and/or hardware, has at its disposal functions such as: generating a digital signature with the aid of the private key PA, authenticity check of the digital signature of any desired peer X by means of its public key QX which is contained in X's certificate, validity check of a digital certificate via the authenticity check of its digital signature, created by the server CA by means of its public key QCA which is contained in the (root) certificate of CA, encrypting a confidential message to peer X by means of the public key QX from the certificate of peer X, decrypting a confidential message from peer X to peer A by means of the private key PA of peer A.

FIG. 5 shows a program sequence of a certificate distribution, as reproduced schematically in FIG. 2. For certificate distribution it should be stated in a preliminary remark that all network subscribers have a self-signed certificate of the certificate-generating server CA permanently integrated in the P2P network. Thus each network subscriber has a public key QCA of the certificate-generating server CA. All peers A,B, . . . N, also have an identification ID which is, for example, the network address in said P2P network. The certificate-generating server CA has generated the certificate ZX for the network subscriber peer X of the P2P network, i.e. signed with its private key PCA of the server. This certificate links a public key QX to its identity X.

Certificate distribution subsequently takes place according to the following method steps: the server sends a certificate to a specific peer. In the present example this is the peer A in the P2P network. The signature of the certificate ZX may be checked in peer A by means of the public key QCA that is known to it. If it is established that the signature is invalid, the certificate is not forwarded but deleted. It is also possible for the certificate server itself to be a network subscriber of this type in the P2P network.

The identification ID, which determines on which peers a resource is stored in the P2P network, of the certificate ZX is established in peer A according to a method that is conventional in P2P networks and which is dependent on the P2P algorithm/protocol used. See Petar Maymounkov, David Mazieres, New York University, Kademlia: A Peer to Peer Information System Based on XOR Metric, 2001 or Stoica, Morris, Karger, Kaashoek, Balakrishnan, MIT Laboratory for computer Science: Chord: A Scalable Peer-to-peer Lookup Service for Internet Applications, August 2001, for example with regard to P2P algorithms/protocols. Peer A for example works out this ID of the certificate in such a way that it emerges from an unambiguous identification of peer X, so the certificate can be found in the P2P network and extracted only with knowledge of this identification.

Within the P2P network peer A looks for peer M, the identification ID of which best matches the ID of the certificate. The match is based on a metric of the P2P network system.

Peer A sends the certificate ZX to peer M.

The signature of the certificate can also be checked in the computer peer M by means of the public key QCA. If the signature is o.k., the computer stores the certificate; otherwise the certificate is deleted.

The certificate of peer X is available as a resource in the P2P network as described above, i.e. it can be sought in the P2P network and extracted by any peer A,B, . . . N, that requires it. The invention thus brings with it the advantage that the certificate ZX is still available even if the server and peer X are not.

FIG. 6 schematically reproduces a flow diagram of an authenticity check. With regard to the authenticity check it should be noted that all peers have self-signed certificates of the certificate-generating server CA permanently integrated in the P2P network. Thus each peer A,B, . . . N, has a public key QCA of the certificate-generating server CA. All peers A,B, . . . N have an identification ID which is used as a network address in the P2P network. The certificate for peer X exists as a resource in the P2P network. Thus for example a data record, such as a data file, service inquiry or message, etc., can be signed by peer x with its private key PX and be sent to peer X or be stored in the P2P network in another computer peer M, peer N. Peer C contains this data record of peer X or of a third computer peer M.

For the authenticity check, i.e. to check that the data record really originates from peer X, therefore peer C now requires the certificate ZX of peer X.

Peer C determines, for example from an unambiguous identification of peer X, the identification ID of the certificate of peer X.

In a subsequent method step peer C uses this ID to search a network subscriber, on which the certificate is stored, and obtains peer M as a destination.

The computer peer C induces peer M to send it the certificate. The validity of the certificate ZX is accordingly checked in peer C and the authenticity of the data record received from peer X is subsequently checked. If the certificate and the authenticity are o.k., peer C processes the data record which was sent by peer X. A P2P network access check is thus also possible—only subscribers which have received a certificate from the certificate-generating server CA are authorized to generate data records for processing by other subscribers.

As a result of the fact that the certificate is stored in the resources of the P2P network, any peer A,B, . . . N can accordingly check the authenticity of data records in the network of the P2P network. The check may still be conducted even if the server and the network subscriber peer X are not available.

FIG. 7 schematically reproduces the sequence of an encrypted storage procedure. The following sequence of an encrypted storage procedure takes place in a similar manner to the above-described authenticity check. Starting from peer C, an encrypted message to peer X is to be stored in the network. The computer peer C determines, for example from an unambiguous identification of peer X, the ID of the certificate of peer X. The computer peer X uses this ID to search a peer, on which the certificate is stored, and obtains peer M as the destination. The computer peer C induces peer M to send it the certificate. Peer C checks the validity of the certificate of peer X. In peer C the message is encrypted using the public key QX from the certificate of peer X. Peer C can accordingly store the encrypted massage in the P2P network.

If peer X receives the encrypted message, only peer X can decrypt the message, directed to it by peer C, using its private key PX.

With this sequence of an encrypted storage procedure any peer A,B, . . . peer N, can send encrypted messages to other subscribers of the P2P network or store them. This sending of messages to other subscribers of the P2P network and storing thereof can take place independently of a server or the availability of the destination peer.

Methods for securing communication of devices or network subscribers in P2P networks. In these networks certification information about devices and users is required in order to check the authenticity of information signed thereby and to transmit confidential information thereto in encrypted form. Whoever requires this certification information can request it from the network subscriber itself or from external servers. According to the invention this information is also stored as a resource in the P2P network. This brings with it the advantage that the information is available even if the device or user is not available and no server is available. It also brings with it the further advantage that the authenticity check is permanently ensured and information can be confidentially stored even if device and user are temporarily unavailable.

1.-5. (canceled)

6. A circuit arrangement for securing communication between network subscribers within a peer-to-peer network, comprising:
a crypto module for handling cryptographic functions;
a network module for communication with a further network subscriber and a server that is not within to the peer-to-peer network;
a first memory module comprising a plurality of memory sub-modules that store association features relating to a first network subscriber; and
a second memory module comprising memory sub-modules for buffering a certificate of the further network subscriber,
wherein the certificate of the further network subscriber is requested by another other network subscriber.

7. The circuit arrangement as claimed in claim 6, wherein the arrangement is disposed in the first network subscriber.

8. The circuit arrangement as claimed in claim 6, wherein the server produces the certificate that is stored in the second memory module.

9. The circuit arrangement as claimed in claim 8, wherein the arrangement is disposed in the first network subscriber.

10. A method for securing communication between network subscribers within a peer-to-peer network, comprising:
providing cryptographic functions via a crypto module, the functions selected from the group consisting of generating a signature, authenticity check of a signature, validity check of a certificate, encrypting a confidential message to be sent, decrypting a received message;
communicating via a network module with a further network subscriber and with a server that is not within to the peer-to-peer network;
storing association features relating to a first network subscriber in a first memory module;
storing a certificate of the further network subscriber in a second memory module; and
receiving a request by the further network subscriber for the certificate of the further network subscriber.

11. The method as claimed in claim 10, further comprises receiving the certificate of the further network subscriber from the server prior to the storing of the certificate.

12. The method as claimed in claim 11, wherein the certificate of the further network subscriber is created via the server.
